(19) United States
(12) Patent Application Publication
(10) Pub. No.: US 2026/0226260 A1
(43) Pub. Date: Aug. 6, 2026

(54) HIGH DENSITY POLYETHYLENE COMPOSITIONS

(71) Applicant: Dow Global Technologies LLC, Midland, MI (US)

(72) Inventors: Fengyi Zhang, Missouri City, TX (US); Keran Lu, Sandy Spring, GA (US)

(21) Appl. No.: 19/148,750

(22) PCT Filed: Mar. 12, 2024
(86) PCT No.: PCT/US2024/019534

§ 371 Date: Jul. 17, 2025

Related U.S. Application Data
(60) Provisional application No. 63/495,560, filed on Apr. 12, 2023.

(51) Int. Cl. C08L 23/0807; B29C 45/00; B29K 23/00

(52) U.S. Cl. CPC C08L 23/0815; B29C 45/0001; B29K 2023/0633; B29K 2023/065; B29K 2995/0012; B29K 2995/0063; B29K 2995/0077; C08L 2205/025; C08L 2205/03; C08L 2207/062; C08L 2207/066

(57) ABSTRACT

The present invention relates to a high density polyethylene composition. The high density polyethylene composition includes a HDPE component and an LDPE component. The HDPE component has a density of from 0.945 to 0.960 g/cm³ and a melt index (I_{2.16}) of from 0.5 to 60 dg/min. The LDPE component has a density from 0.900 to 0.930 g/cm³ and a melt index from 5 to 100 dg/10 min. When the HDPE component and LDPE component are combined at certain concentrations, the resulting high density polyethylene composition according to embodiments disclosed herein can have unexpected and highly desirable shrinkage anisotropy and can be used in forming molded articles with desirable properties.

### TECHNICAL FIELD

This present invention relates to the field of polyethylene compositions.

### BACKGROUND

High density polyethylene (HDPE) and polymer blends that contain HDPE are commonly used in packaging, such as bottles, jars and their closures. The packaging can be molded using known molding techniques, such as injection molding, compression molding and blow molding.

Injection molding is commonly used for making complex shaped articles, such as caps, closures, threaded items and hinged items. Shrinkage anisotropy is a known problem for molded HDPE articles, and especially articles made by injection molding. HDPE shrinks as it cools, but it can shrink at a higher rate in the direction that it flows through the mold, as compared to shrinkage transverse to the direction of flow. This difference in shrinkage, called shrinkage anisotropy, distorts the shape of the molded article, causing it to warp and/or dimple. In packaging, part warpage may result in poor performance, such as badly fitted caps or hinges that tear with use. Distortion becomes more likely as the size of the molded article increases.

Techniques to reduce shrinkage anisotropy are known, but they have drawbacks. Allowing the part to cool longer in the mold can reduce shrinkage anisotropy but also reduces line speeds. Accordingly, polyethylene compositions having reduced shrinkage anisotropy may be desired. In particular, it may be desirable for the composition to retain desirable physical properties of HDPE, while having reduced shrinkage anisotropy.

### SUMMARY

A first aspect of the invention is a high density polyethylene composition comprising: a) from 70.0 to 99.9 weight percent of a high density polyethylene (HDPE) component having a density from 0.945 to 0.960 g/cm³ and a melt index (I_{2.16}, abbreviated MI_{H})) from 0.5 to 60 dg/min., and b) a low density polyethylene (LDPE) component having a density from 0.900 to 0.930 g/cm³ and a melt index (I_{2.16}) from 5 to 100 dg/min., in an amount of at most 30.0 weight percent and at least (a) 0.1 weight percent or (b) a weight percentage equal to 0.5×MI_{H}, whichever is greater, wherein the high density polyethylene composition has a density from 0.940 to 0.960 g/cm³ and a melt index (I_{2.16}) of no more than 70 dg/min, and wherein weight percentages are based on the combined weight of the HDPE component and the LDPE component.

A second aspect of the invention is a process for making a molded article comprising the steps of: (1) injecting the high density polyethylene composition according to embodiments disclosed herein into a mold; (2) cooling the high density polyethylene composition in the mold until solidified; and (3) releasing the high density composition from the mold.

A third aspect of the invention is a molded article that comprises the high density polyethylene composition in the first aspect of the invention.

In some embodiments, molded articles of the present invention can have physical properties similar to the HDPE component, but can have lower shrinkage anisotropy than the HDPE component.

### DETAILED DESCRIPTION

The high density polyethylene compositions of the present invention comprise an HDPE component and a LDPE component. Both the HDPE component and the LDPE component are based on different varieties of polyethylene polymers.

The term “polyethylene” refers to polymers comprising a majority amount (>50 mol %) of units which have been derived from ethylene monomer. This includes polyethylene homopolymers or copolymers (meaning units derived from two or more comonomers).

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

In some embodiments, a polyethylene (e.g., HDPE or LDPE) is a homopolymer containing no measurable remnants of comonomer. In some embodiments, a polyethylene is a copolymer in which a minority of repeating units are derived from unsaturated comonomers.

Examples of suitable comonomers used to make polyethylene may include alpha-olefins. Suitable alpha-olefins may include those containing from 3 to 20 carbon atoms (C3-C20). For example, the alpha-olefin may be a C4-C20 alpha-olefin, a C4-C12 alpha-olefin, a C3-C10 alpha-olefin, a C3-C8 alpha-olefin, a C4-C8 alpha-olefin or a C6-C8 alpha-olefin. In some embodiments, the alpha-olefin is selected from the group consisting of propylene, 1-butene, 1-pentene, 1-hexene, 4-methyl-1-pentene, 1-heptene, 1-octene, 1-nonene and 1-decene. In some embodiments, the alpha-olefin is selected from the group consisting of 1-butene, 1-hexene, and 1-octene. In some embodiments, the alpha-olefin is selected from the group consisting of 1-hexene and 1-octene.

### HDPE Component

The HDPE composition of this invention comprises an HDPE component, which comprises one or more HDPE polymers. The HDPE component has a density from 0.945 to 0.960 g/cm³ and a melt index (I_{2.16}) from 0.5 to 60 dg/min.

In some embodiments, the HDPE component comprises an HDPE homopolymer.

In some embodiments, the HDPE component comprises an HDPE copolymer. In some embodiments, the HDPE copolymer comprises at least 95 weight percent repeating units derived from ethylene, or at least 96 weight percent or at least 97 weight percent or at least 98 weight percent or at least 99 weight percent, with the remaining repeating units derived from unsaturated comonomers. In some embodiments, the HDPE copolymer contains at least 0.5 weight percent repeating units derived from comonomers, or at least 1 weight percent or at least 2 weight percent or at least 3 weight percent, with the remaining repeating units derived from ethylene monomer. It is well known how to select comonomers, comonomer content and molecular weight to obtain an HDPE copolymer having the desired density and melt index. In some embodiments, wherein the comonomer is a higher molecular weight comonomer such as 1-octene, the comonomer content may be in the lower part of the range listed above. In some embodiments, wherein the comonomer is a lower molecular weight comonomer such as 1-butene, the comonomer content may be in the higher part of the range listed above.

In some embodiments, the density of the HDPE component is at least 0.948 g/cm³ or at least 0.950 g/cm³ or at least 0.951 g/cm³. In some embodiments, the density of the HDPE component is at most 0.958 g/cm³ or at most 0.956 g/cm³ or at most 0.954 g/cm³.

In some embodiments, the melt index (I_{2.16}) of the HDPE component is at least 0.5 dg/min. or at least 1.0 dg/min. or at least 1.4 dg/min. In some embodiments, the melt index (I_{2.16}) of the HDPE component is at most 50 dg/min. or at most 40 dg/min. or at most 30 dg/min. or at most 20 dg/min. or at most 15 dg/min. or at most 12 dg/min. or at most 10 dg/min. or at most 8 dg/min. or at most 7 dg/min.

In some embodiments, the melt-flow ratio (I_{21.6}/I_{2.16}) of the HDPE component is at least 20 or at least 30 or at least 35. In some embodiments, the melt-flow ratio (I_{21.6}/I_{2.16}) of the HDPE component is at most 100 or at most 95 or at most 90. In some embodiments, the melt-flow ratio (I₁₀/I_{21.6}) of the HDPE component is at least 5 or at least 10 or at least 12. In some embodiments, the melt-flow ratio (I₁₀/I_{2.16}) of the HDPE component is at most 20 or at most 18 or at most 16.

In some embodiments, the number average molecular weight (Mn) of the HDPE component is at least 7000 g/mol. or at least 8000 g/mol. or at least 9000 g/mol. In some embodiments, the number average molecular weight (Mn) of the HDPE component is at most 16,000 g/mol. or at most 15,000 g/nol. or at most 14,000 g/mol.

In some embodiments, the weight average molecular weight (Mw) of the HDPE component is at least 40,000 g/mol. or at least 60,000 g/mol. or at least 90,000 g/mol. or at least 100,000 g/mol. In some embodiments, the weight average molecular weight (Mw) of the HDPE component is at most 350,000 g/mol. or at most 300,000 g/mol. or at most 275,000 g/mol.

In some embodiments, the molecular weight distribution (Mw/Mn) of the HDPE component is at least 4 or at least 5 at least 8 or at least 9 or at least 10. In some embodiments, the molecular weight distribution (Mw/Mn) of the HDPE component is at most 35 at most 30 or at most 25 or at most 22.

In some embodiments, the HDPE component has a unimodal molecular weight distribution. In some embodiments, the HDPE component has a bimodal molecular weight distribution. In some embodiments, the HDPE component has a multimodal molecular weight distribution.

In some embodiments, the HDPE component is selected to have properties useful for injection molded applications or for closure applications or both.

In some embodiments, the tensile yield stress of the HDPE component is at least 18 MPa or at least 20 MPa or at least 22 MPa or at least 23 MPa, when measured as set out in the Test Methods. There is no maximum desired tensile yield stress, but in some embodiments tensile yield stress above 40 MPa or 30 MPa may be unnecessary.

In some embodiments, the tensile yield strain of the HDPE component is at least 6 percent or at least 7 percent or at least 8 percent or at least 9 percent, when measured as set out in the Test Methods. In some embodiments, the tensile yield strain of the HDPE component is at most 12 percent or at most 11 percent or at most 10 percent, when measured as set out in the Test Methods.

In some embodiments, the tensile break stress of the HDPE component is at least 15 MPa or at least 18 MPa or at least 20 MPa or at least 22 MPa, when measured as set out in the Test Methods. In some embodiments tensile break stress is at most 40 MPa or 38 MPa or 30 MPa or 25 MPa.

In some embodiments, the elongation to break of the HDPE component is at least 500 percent or at least 600 percent or at least 650 percent, when measured as set out in the Test Methods. In some embodiments, the elongation to break of the HDPE component is at most 1200 percent or at most 1000 percent or at most 950 percent, when measured as set out in the Test Methods.

In some embodiments, the environmental stress crack resistance (ESCR) of the HDPE component is at least 100 hours or at least 250 hours or at least 500 hours or at least 800 hours or at least 1000 hours or at least 1500 hours, when measured as set out in the Test Methods. In some embodiments, the ESCR of the HDPE component is at most 3000 hours or 2500 hours.

In some embodiments, the shrinkage anisotropy of the HDPE component is at least 1.5 or at least 2 or at least 3 or at least 4, when measured as set out in the Test Methods.

In some embodiments, the HDPE component may comprise additives in addition to the HDPE polymer(s). Additives for polyolefin polymers are described in numerous publications, such as the pamphlet: Tolinski, “Additives for Polyolefins. Getting the Most out of Polypropylene, Polyethylene and TPO (Second Edition)” published by the Plastics Design Library in 2015. Examples of common additives include antistatic agents, color enhancers, dyes, lubricants, fillers, pigments, primary antioxidants, secondary antioxidants, processing aids, UV stabilizers, nucleators, slip agents such as erucamide, antiblock agents such as talc, and combinations thereof. In some embodiments, additives make up no more than 5 weight percent of the HDPE component or no more than 4 weight percent or no more than 3 weight percent or no more than 2 weight percent or no more than 1 weight percent. In some embodiments, additives make up essentially 0 weight percent of the HDPE component.

In some embodiments, the HDPE component may comprise minor amounts of other polymers, in addition to the HDPE polymer(s), as long as the overall HDPE component meets the required density and melt index. In some embodiments, the quantity of other polymers in the HDPE component is no more than 10 weight percent or no more than 5 weight percent or no more than 2 weight percent or no more than 1 weight percent. In some embodiments, the HDPE component contains no measurable polymers (0 weight percent) other than HDPE polymer(s).

Suitable HDPE polymers for the HDPE component are commercially available, such as under the CONTINUUM™, UNIVAL™, and DOWT™ HDPE trademarks.

### LDPE Component

The HDPE composition of this invention comprises a low density polyethylene (LDPE) component, which contains one or more LDPE polymers. The LDPE component in this invention has a density from 0.900 to 0.930 g/cm³ and a melt index (I_{2.16}) from 5 to 100 dg/min.

In some embodiments, the LDPE component comprises an LDPE homopolymer, and in some embodiments it contains an LDPE copolymer.

In some embodiments, the density of the LDPE component is at least 0.910 g/cm³ or at least 0.915 g/cm³ or at least 0.917 g/cm³. In some embodiments, the density of the LDPE component is at most 0.928 g/cm³ or at most 0.925 g/cm³ or at most 0.924 g/cm³.

In some embodiments, the melt index (I_{2.16}) of the LDPE component is at least 7 dg/min. or at least 10 dg/min. or at least 20 dg/min. or at least 30 dg/min. or at least 40 dg/min. or at least 50 dg/min. In some embodiments, the melt index (I_{2.16}) of the LDPE component is at most 80 dg/min. or most 70 dg/min. or most 60 dg/min. or most 50 dg/min. or most 40 dg/min. or most 30 dg/min. or most 20 dg/min.

In some embodiments, the number average molecular weight (Mn) of the LDPE component is at least 7000 g/mol. or at least 8000 g/mol. or at least 9000 g/mol. In some embodiments, the number average molecular weight (Mn) of the LDPE component is at most 12,000 g/mol. or at most 10,000 g/mol. or at most 9500 g/mol.

In some embodiments, the weight average molecular weight (Mw) of the LDPE component is at least 50,000 g/mol. or at least 60,000 g/mol. or at least 65,000 g/mol. In some embodiments, the weight average molecular weight (Mw) of the LDPE component is at most 90,000 g/mol. or at most 80,000 g/mol. or at most 75,000 g/mol.

In some embodiments, the molecular weight distribution (Mw/Mn) of the LDPE component is at least 4 or at least 5 or at least 6 or at least 7. In some embodiments, the molecular weight distribution (Mw/Mn) of the LDPE component is at most 14 or at most 12 or at most 10 or at most 8.

In some embodiments, the LDPE component has higher levels of long-chain branching than the HDPE component. Long chain branching in polymers can be characterized by the long chain branching frequency (LCBf), measuring long chain branches per 1000 carbon atoms.

In some embodiments, the long chain branching frequency (LCBf) of the LDPE component is at least 0.10 or at least 0.30 or at least 0.3 or at least 0.50 or at least 0.60. In some embodiments, the long chain branching frequency (LCBf) of the LDPE component is at most 5.0 or at most 2 or at most 1.5 or at most 1.25 or at most 1.

In some embodiments, the LDPE component may comprise additives, as previous described for the HDPE component.

In some embodiments, the LDPE component may comprise minor amounts of other polymers, in addition to the LDPE polymer(s), as long as the overall LDPE component meets the required density and melt index and the polymers in the LDPE component are miscible with each other. In some embodiments, the quantity of other polymers in the LDPE component is no more than 10 weight percent or no more than 5 weight percent or no more than 2 weight percent or no more than 1 weight percent. In some embodiments, the LDPE component contains no measurable polymers (0 weight percent) other than LDPE polymers.

Suitable low density polyethylene resins are commercially available, such as DOW™ LDPE 9595.

### HDPE Composition and Use

The HDPE composition of this invention comprises both the LDPE component and the HDPE component. The concentration of the HDPE component is from 70 to 99.9 weight percent. The concentration of the LDPE component is at most 30.0 weight percent and at least (a) 0.1 weight percent or (b) a weight percentage equal to 0.5×the melt index (I_{2.16}) of the HDPE component (abbreviated MI_{H}), whichever is greater. All weight percentages are based on the combined weight of the HDPE component and the LDPE component. It is called an “HDPE composition” because the overall density of the composition is in the range suitable for HDPE polymers. The HDPE composition has a density from 0.940 to 0.960 g/cm³ and a melt index (I_{2.16}) of no more than 70 dg/min.

In some embodiments, the HDPE composition comprises at least 0.5 weight percent LDPE component or at least 1 weight percent or at least 2 weight percent or at least 3 weight percent or at least 5 weight percent or at least 7 weight percent or at least 9 weight percent. In some embodiments, the HDPE composition comprises at most 25 weight percent LDPE component or at most 20 weight percent or at most 15 weight percent or at most 12 weight percent.

In some embodiments, the weight percent concentration of LDPE component in the HDPE composition is at least 0.6×MI_{H} or 0.75×MI_{H} or at least 0.9×MI_{H} or at least 1.2×MI_{H}. In some embodiments, the weight percent concentration of LDPE component in the HDPE composition is at most 15×MI_{H} or at most 10×MI_{H} or at most 5×MI_{H}.

In some embodiments, the HDPE composition comprises at least 75 weight percent HDPE component or at least 80 weight percent or at least 85 weight percent or at least 88 weight percent. In some embodiments, the HDPE composition contains at most 99.5 weight percent HDPE component or at most 99 weight percent or at most 98 weight percent or at most 97 weight percent or at most 95 weight percent or at most 93 weight percent or at most 91 weight percent.

The HDPE composition may comprise additives and other polymers, as previously described for the HDPE component and the LDPE component. Examples of additives and their concentration are as previously described.

In some embodiments, the HDPE composition may comprise minor amounts of other polymers, in addition to the HDPE component and the LDPE component, as long as the overall HDPE composition meets the required density and melt index. In some embodiments, the quantity of other polymers in the HDPE composition is no more than 10 weight percent or no more than 5 weight percent or no more than 2 weight percent or no more than 1 weight percent. In some embodiments, the HDPE composition contains no measurable polymers (0 weight percent) other than the HDPE component and the LDPE component.

In some embodiments, the density of the HDPE composition is at least 0.945 g/cm³ or at least 0.948 g/cm³ or at least 0.950 g/cm³ or at least 0.952 g/cm³. In some embodiments, the density of the HDPE composition is at most 0.960 g/cm³ or at most 0.955 g/cm³ or at most 0.954 g/cm³.

In some embodiments, the melt index (I_{2.16}) of the HDPE composition is at least 0.5 dg/min. or at least 0.7 dg/min. or at least 0.8 dg/min. or at least 0.9 dg/min. or at least 1 dg/min. In some embodiments, the melt index (I_{2.16}) of the HDPE composition is at most 50 dg/min. or at most 30 dg/min. or at most 20 dg/min. or at most 15 dg/min. or at most 12 dg/min. or at most 10 dg/min. or at most 8 dg/min. or at most 7 dg/min. or at most 5 dg/min.

In some embodiments, the number average molecular weight (Mn) of the HDPE composition is at least 8000 g/mol. or at least 9000 g/mol. or at least 9500 g/mol. In some embodiments, the number average molecular weight (Mn) of the HDPE composition is at most 15,000 g/mol. or at most 14,000 g/mol. or at most 13,000 g/mol.

In some embodiments, the weight average molecular weight (Mw) of the HDPE composition is at least 80,000 g/mol. or at least 90,000 g/mol. or at least 95,000 g/mol. In some embodiments, the weight average molecular weight (Mw) of the HDPE composition is at most 350,000 g/mol. or at most 300,000 g/mol. or at most 275,000 g/mol.

In some embodiments, the molecular weight distribution (Mw/Mn) of the HDPE composition is at least 8 or at least 9 or at least 10. In some embodiments, the molecular weight distribution (Mw/Mn) of the HDPE composition is at most 30 or at most 25 or at most 22 or at most 20 or at most 15.

In some embodiments, the HDPE composition has properties useful for injection molded applications or for closure applications or both.

In some embodiments, the tensile yield stress of the HDPE composition is at least 20 MPa or at least 22 MPa or at least 24 MPa or at least 26 MPa, when measured as set out in the Test Methods. In some embodiments tensile yield strength of the HDPE composition is less than 35 MPa or 32 MPa.

In some embodiments, the tensile yield strain of the HDPE composition is at least 6 percent or at least 7 percent or at least 8 percent or at least 9 percent, when measured as set out in the Test Methods. In some embodiments, the tensile yield strain of the HDPE composition is at most 12 percent or at most 11 percent or at most 10 percent, when measured as set out in the Test Methods.

In some embodiments, the tensile break stress of the HDPE composition is at least 15 MPa or at least 16 MPa or at least 17 MPa or at least 19 MPa or at least 21 MPa, when measured as set out in the Test Methods. In some embodiments, the tensile break stress of the HDPE composition is no more than 40 MPa or 38 MPa or 33 MPa.

In some embodiments, the elongation to break of the HDPE composition is at least 600 percent or at least 700 percent or at least 800 percent, when measured as set out in the Test Methods. In some embodiments, the elongation to break of the HDPE composition is at most 1000 percent or at most 900 percent, when measured as set out in the Test Methods.

In some embodiments, the environmental stress crack resistance (ESCR) of the HDPE composition is at least 20 hours or at least 100 hours or at least 120 hours or at least 150 hours, when measured as set out in the Test Methods. In some embodiments, the ESCR is no more than 2000 hours, 1000 hours or 600 hours.

In some embodiments, the shrinkage anisotropy of the HDPE composition is at most 3 or at most 2.9 or at most 2.8 or at most 2.7 or at most 2.5 or at most 2.3 or at most 2.1 or at most 1.9 or at most 1.7. Anisotropy of 1 would mean that the composition is essentially isotropic, and results below 1 would be undesirable in many cases. In some embodiments shrinkage anisotropy below 1.3 or 1.5 may be unnecessary.

In some embodiments, the shrinkage anisotropy of the HDPE composition is at most 95 percent of shrinkage anisotropy of the HDPE component or at most 90 percent or at most 88 percent or at most 85 percent or at most 83 percent. In some embodiments, the shrinkage anisotropy of the HDPE composition is at least 50 percent of shrinkage anisotropy of the HDPE component or at least 60 percent or at least 70 percent.

The HDPE composition can be made by melt-blending the HDPE component and the LDPE component, optionally with other additives. Equipment for melt blending is commercially available, and processes for melt blending are well-known. In summary, powders or pellets of the components are subjected to heat and shear in an extruder, blender or kneader or similar equipment until they melt and become homogeneously blended together. Extruders are commonly used blending equipment, and extrusion is a commonly used blending technology. In some embodiments, the melt temperature during blending is at least 180° C. or at least 185° C. or at least 190° C. In some embodiment, the melt temperature during blending is at most 210° C. or at most 205° C. or at most 200° C.

The melt blended HDPE composition can be fabricated to make molded articles immediately after it is blended while still molten, such as by feeding from the extruder into an injection molding, blow-molding or compression molding or other end use process. Alternatively, the melt blended HDPE composition can be made into pellets or other intermediate form for storage and shipping, such as by extruding, chopping and cooling the molten HDPE composition. Suitable pelleting equipment is commercially available, with instructions for its use. The pellets can be remelted at a later time and used in known fabrication processes.

The composition can be used in conventional fabrication processes to make shaped articles, such as by injection molding, compression molding or blow molding. Each of these processes is well-known and described in many publications, and equipment to practice it is commercially available.

In an injection molding process, the molten polymer is injected into a mold, cooled to form a molded part and released from the mold. Likewise, blow-molded bottles that contain a threaded opening are frequently made by a hybrid process called injection stretch blow molding, in which a preform that contains the threaded opening is made first by injection molding and then the remainder of the bottle is blow-molded from the preform.

In a compression molding process, a two-piece mold provides a cavity having the shape of a desired molded article. The mold is heated, and an appropriate amount of molten molding compound from an extruder is loaded into the lower half of the mold. The two parts of the mold are brought together under pressure. The molding compound, softened by heat, is thereby welded into a continuous mass having the shape of the cavity. The continuous mass may be hardened via chilling under pressure in the mold.

Blow molding processes include extrusion blow molding, injection blow molding and injection stretch blow molding.

In an extrusion blow molding process, the HDPE composition is melted and extruded as a hollow tube, called a parison. The parison is enclosed in a cooled metal mold for a shaped article such as a bottle, container or part. Air or a neutral gas such as nitrogen is then blown into the parison, inflating it into the shape of the mold. After the HDPE composition has cooled sufficiently, the mold is opened, and the part is ejected.

In an injection blow molding process, the HDPE composition is melted and injected into a metal mold for a shaped article such as a bottle, container or part. Air or a neutral gas such as nitrogen is then blown into the mold, inflating the HDPE composition into the shape of the mold. After the HDPE composition has cooled sufficiently, the mold is opened, and the part is ejected.

In an injection stretch blow molding process, a preform of the HDPE composition is made by injection molding. In some embodiments, the final neck features for the final molded item (such as threading on a bottle neck) are made on the preform. Next, the molten preform is placed in a mold. Air or a neutral gas such as nitrogen is then blown into the preform, inflating it into the shape of the mold. After the HDPE composition has cooled sufficiently, the mold is opened, and the part is ejected. The preform may be blown immediately after it is formed, or it may be cooled and then reheated and blown later.

Each of these processes makes a shaped article comprising the composition of the present invention. Shaped articles can come in a variety of shapes and sizes, from small articles such as pill bottles, to medium articles such as drink bottles, to large items such as outdoor furniture, trash cans and auto parts. In some embodiments, the composition of the present invention may be the only polymer in the shaped article. In some embodiments, the shaped article may contain layers or zones of different polymers to serve different purposes in the article.

In some embodiments, shaped articles that contain the HDPE composition of this invention have at least one dimension (height, width or depth) greater than 5 cm or greater than 10 cm or greater than 15 cm or greater than 20 cm. In some embodiments, shaped articles that contain the HDPE composition of this invention have at least two dimensions at 90° angles to each other greater than 5 cm or greater than 10 cm or greater than 15 cm or greater than 20 cm.

Compositions of this invention may be especially useful in caps and closures for containers. Caps and closures must maintain their shape in order to fit correctly on the container. Further, many caps and closures have plastic hinges. The hinges must maintain their shape in order to smoothly open and close multiple times without tearing. Reduced shrinkage anisotropy of the compositions can help the caps, closures and hinges to maintain their shape.

### Test Methods

Parameters described in this application can be measured using the following measurements:

| | |
|---|---|
| Parameter | Test |
| Density | See Description Below |
| Melt Index | ASTM D1238 (at 190° C. with 2.16 kg weight) |
| Flow Index | ASTM D1238 (at 190° C. with 21.6 kg weight) |
| Tensile Yield Stress, Tensile Yield | ASTM D638 (Test Speed = 2 in/min) |
| Strain, Tensile Break Stress and | |
| Elongation to Break | |
| Flexural Modulus (2% Secant) | ASTM D790 (Test Speed = 0.05 in/min) |
| Environmental Stress Crack Resistance | ASTM D1693 (Condition B, 50° C., 10% Igepal, F50) |
| (ESCR) | |
| Number Average (Mn) and Weight | See Description Below |
| Average (M_{w}) Molecular Weight | |
| Long Chain Branching Frequency | See Description Below |
| (LCBf) | |
| Shrinkage Anisotropy | ISO 294-4: 2018 |

### Melt Index and Flow Index

Melt index, or I_{2.16}, for polyethylene polymers is determined according to ASTM D1238 at 190° C., 2.16 kg. High load melt index or Flow Index, or I_{21.6}. for polyethylene polymers is determined according to ASTM D1238 at 190° C., 21.6 kg. Measurements are reported in dg/min.

### Density

Samples that are measured for density are prepared according to ASTM D4703. Measurements are made within one hour of sample pressing using ASTM D792, Method B.

### Gel Permeation Chromatography (GPC) for Measurement of Molecular Weight and Long Chain Branching Frequency (LCBf).

Number average molecular weight (Mn), weight average molecular weight (Mw), and Molecular Weight Distribution (Mw/Mn) are measured using gel permeation chromatography (GPC). also known as size exclusion chromatography (SEC). This technique utilizes an instrument containing columns packed with porous beads, an elution solvent, and detector in order to separate polymer molecules of different sizes.

Polymer molecular weight is characterized by high temperature gel permeation chromatography (GPC). The chromatographic system consists of a Polymer Laboratories “GPC-220 high temperature” chromatograph, equipped with a Precision Detectors (Amherst, Mass.) 2-angle laser light scattering detector, Model 2040, and a 4-capillary differential viscometer detector, Model 210R, from Viscotek (Houston, Tex.). The 15° angle of the light scattering detector is used for calculation purposes.

Data collection is performed using PolymerChar (Valencia, Spain) GPC One Instrument Control. The system is equipped with an on-line solvent degas device from Polymer Laboratories. The carousel compartment and column compartment are operated at 150° C. The columns are four Polymer Laboratories “Mixed A” 20 micron columns, and one 20 um guard column. The polymer solutions are prepared in 1,2,4 trichlorobenzene (TCB). The samples are prepared at a concentration of 0.1 grams of polymer in 50 ml of solvent. The chromatographic solvent and the sample preparation solvent contain 200 ppm of butylated hydroxytoluene (BHT). Both solvent sources are nitrogen sparged. Polyethylene samples are stirred gently at 160° C. for 4 hours. The injection volume is 200 μl, and the flow rate is 1.0 ml/minute.

Calibration of the GPC column set is performed with 21 narrow molecular weight distribution polystyrene standards. The molecular weights of the standards range from 580 to 8,400,000, and are arranged in 6 “cocktail” mixtures, with at least a decade of separation between individual molecular weights. The polystyrene standard peak molecular weights are converted to polyethylene molecular weights using the following equation (as described in Williams and Ward, J. Polym. Sci., Polym. Let., 6, 621 (1968)):

$${M}_{polyethylene} = A \times {( {M}_{polystyrene} )}^{B} ,$$

where M is the molecular weight, A has a value of 0.4316, and B is equal to 1.0. A fifth order polynomial is used to fit the respective polyethylene-equivalent calibration points. The total plate count of the GPC column set is performed with Eicosane (prepared at 0.04 g in 50 milliliters of TCB, and dissolved for 20 minutes with gentle agitation.) The plate count and symmetry are measured on a 200 microliter injection according to the following equations:

$$PlateCount = 5.54 * {( \frac{RV at Peak Maximum}{Peak Width at 1 / 2 height} )}^{2}$$

where RV is the retention volume in milliliters, and the peak width is in milliliters.

$$Symmetry = \frac{( Rear Peak Width at \frac{1}{10} height ) - ( RV at Peak Maximum )}{( RV at Peak Maximum ) - ( Front Peak Width at \frac{1}{10} height )} ,$$

where RV is the retention volume in milliliters, and the peak width is in milliliters. The calculations of Mn, Mw, and Mz are based on GPC results using the RI detector are determined from the following equations:

$$\overline{Mn} = \frac{{\sum }^{i} {RI}_{i}}{{\sum }^{i} ( {RI}_{i} / {McCalibration}_{i} )} ,$$

$$\overline{Mw} = \frac{{\sum }^{i} ( {RI}_{i} * {Mcal}_{i} )}{{\sum }^{i} ( {RI}_{i} )} ,$$

$$\overline{Mz} = \frac{{\sum }^{i} {( {RI}_{i} * {Mcal}_{i} )}^{2}}{{\sum }^{i} ( {RI}_{i} * {Mcal}_{i} )}$$

In order to monitor the deviations over time, which may contain an elution component (caused by chromatographic changes) and a flow rate component (caused by pump changes), a late eluting narrow peak is generally used as a “marker peak”. A flow rate marker is therefore established based on decane flow marker dissolved in the eluting sample. This flow rate marker is used to linearly correct the flow rate for all samples by alignment of the decane peaks. Any changes in the time of the marker peak are then assumed to be related to a linear shift in both flow rate and chromatographic slope. The preferred column set is of 20 micron particle size and “mixed” porosity to adequately separate the highest molecular weight fractions appropriate to the claims. The plate count for the chromatographic system (based on eicosane as discussed previously) should be greater than 20,000, and symmetry should be between 1.00 and 1.12.

The LCB_{f} (in long-chain branches per 1000 carbon atoms) is calculated for each polymer sample by the following procedure:
1) The light scattering, viscosity, and concentration detectors are calibrated with NBS 1475 homopolymer polyethylene (or equivalent linear reference).
2) The light scattering and viscometer detector offsets are corrected relative to the concentration detector as described above in the calibration section (see references to Mourey and Balke).
3) Baselines are subtracted from the light scattering, viscometer, and concentration chromatograms and set integration windows making certain to integrate all of the low molecular weight retention volume range in the light scattering chromatogram that is observable from the refractometer chromatogram.
4) A linear homopolymer polyethylene Mark-Houwink reference line is established by injecting a standard with a polydispersity of at least 3.0, calculate the data file (from above calibration method), and record the intrinsic viscosity and molecular weight from the mass constant corrected data for each chromatographic slice.
5) The LDPE sample of interest is analyzed, the data file (from above calibration method) is calculated, and the intrinsic viscosity and molecular weight from the mass constant, corrected data for each chromatographic slice, is recorded. At lower molecular weights, the intrinsic viscosity and the molecular weight data may need to be extrapolated such that the measured molecular weight and intrinsic viscosity asymptotically approach a linear homopolymer GPC calibration curve.
6) The homopolymer linear reference intrinsic viscosity is shifted at each point (i) by the following factor: IVi=IVi*0.946 where IV is the intrinsic viscosity.
7) The homopolymer linear reference molecular weight is shifted by the following factor: MW=MW*1.57 where MW is the molecular weight.
8) The g′ at each chromatographic slice is calculated according to the following equation:

$${g}^{′} = ( IV ( LDPE ) / IV ( linear reference ) ) ,$$

at the same MW. The IV (linear reference) was calculated from a fifth-order polynomial fit of the reference Mark-Houwink Plot and where IV (linear reference) is the intrinsic viscosity of the linear homopolymer polyethylene reference (adding an amount of SCB (short chain branching) to account for backbiting through Equations 5) and 6) at the same molecular weight (MW)). The IV ratio is assumed to be one at molecular weights less than 3,500 g/mol to account for natural scatter in the light scattering data.
9) The number of branches at each data slice was calculated according to Equation 12 (as described in Zimm, Stockmayer J. Chem. Phys. 17, 1301 (1949)):

$${[ \frac{{IV}_{LDPE}}{{IV}_{linear \_ reference}} ]}_{M}^{1.33} = {[ {( 1 + \frac{{B}_{n}}{7} )}^{1 / 2} + \frac{4}{9} \frac{{B}_{n}}{π} ]}^{- 1 / 2} \qquad ( 12 )$$

10) The average LCB quantity was calculated across all of the slices (i), according to Equation 13:

$${LCB}_{f} = \frac{{\sum }_{M = 3500}^{i} ( \frac{{B}_{ni}}{{M}_{i} * 14000} {C}_{i} )}{\sum {C}_{i}} \qquad ( 13 )$$

### Examples

A bimodal HDPE resin (Bimodal HDPE 1) is made using a catalyst system including a procatalyst, UCAT™ J (commercially available from Univation Technologies, LLC, Houston, TX), and a cocatalyst, triethylaluminum (TEAL), in a gas phase polymerization process. The UCAT™ J catalyst is partially activated by contact at room temperature with an appropriate amount of a 50 percent mineral oil solution of tri-n-hexyl aluminum (TNHA). The catalyst slurry is added to a mixing vessel. While stirring, a 50 percent mineral oil solution of tri-n-hexyl aluminum (TNHA) is added at ratio of 0.17 moles of TNHA to mole of residual tetrahydrofuran (THF) in the catalyst and stirred for at least 1 hour prior to use.

Ethylene and 1-hexene are copolymerized in two fluidized bed reactors. Each polymerization is continuously conducted, after equilibrium is reached, under the respective conditions, as shown below in Tables 1. Polymerization is initiated in the first reactor by continuously feeding the catalyst and cocatalyst (trialkyl aluminum, specifically tri ethyl aluminum or TEAL) into a fluidized bed of polyethylene granules, together with ethylene, hydrogen, and 1-hexene. The resulting copolymer, mixed with active catalyst, is withdrawn from the first reactor, and transferred to the second reactor, using second reactor gas as a transfer medium. The second reactor also contains a fluidized bed of polyethylene granules. Ethylene, hydrogen and hexene are introduced into the second reactor, where the gases come into contact with the polymer and catalyst from the first reactor. Inert gases, nitrogen and isopentane, make up the remaining pressure in both the first and second reactors. In the second reactor, the cocatalyst (TEAL) is again introduced. The final product blend is continuously removed. Table 1 lists the polymerization conditions.

TABLE 1
Bimodal HDPE 1 Reaction Conditions

| 1st Reactor | | |
|---|---|---|
| Temperature | ° C. | 85.0 |
| Pressure | psig | 345 |
| C2 Part. Pressure | psi | 31.9 |
| H2/C2 Molar Ratio | mol/mol | 0.077 |
| C6/C2 Molar Ratio | mol/mol | 0.101 |
| Isopentane % | mol % | 3.1 |
| Catalyst Type | | UCAT ™ J |
| Cat Feed Rate | cc/hr | 14.2 |
| Cocatalyst Type | | TEAL |
| Cocatalyst Concentration | wt % in isopentane | 2.5% |
| Cocat. Feed Rate | cc/hr | 748 |
| Production Rate | lb/hr | 32.3 |
| Bed Weight | lbs | 88.5 |
| Split (% HMW) | % | 41.5% |
| Flow Index, I21 | dg/min | 5.39 |
| Density | g/cm³ | 0.9263 |
| 2nd Reactor | | |
| 2nd Rx Temperature | ° C. | 105 |
| 2nd Rx Pressure | psig | 393 |
| 2nd Rx C2 Part. Pressure | psi | 103 |
| 2nd Rx H2/C2 Molar Ratio | mol/mol | 1.8 |
| 2nd Rx C6/C2 Molar Ratio | mol/mol | 0.001 |
| 2nd Rx Isopentane | mol % | 0.30 |
| 2nd Rx Cocatalyst Type | | TEAL |
| 2nd Rx Cocatalyst Concentration | wt % in isopentane | 2.5% |
| 2nd Cocat. Feed Rate | cc/hr | 150 |
| 2nd Rx Production Rate | lb/hr | 45.6 |
| 2nd Rx Bed Weight | lbs | 146 |

The product (Bimodal HDPE 1) is combined with additives (1000 ppm calcium stearate and 1500 ppm Irgafos™ 168) and fed to a continuous mixer (Kobe Steel, Ltd. LCM-100 continuous mixer), which is closed coupled to a gear pump, and equipped with a melt filtration device and an underwater pelletizing system. It has the properties set out in Table 2.

In addition, the commercial HDPE resins and LDPE resin listed in Table 2 are obtained. Some of the commercial resins may contain additives.

TABLE 2

| | | | | | Tensile | Tensile | Tensile | Elong. | | | |
|---|---|---|---|---|---|---|---|---|---|---|---|
| | | | Melt Index | | Yield | Yield | Break | To | | | |
| | | | (1_{2.16}) | Density | Stress | Strain | Stress | Break | | | Shrinkage |
| | Type | Resin Name | (dg/min.) | (g/cm3) | (MPa) | (%) | (MPa) | (%) | ESCR | LCBf | Anisotropy |
| H1 | Bimodal | Bimodal HDPE 1 | 3.8 | 0.955 | 26.7 | 8.8 | 22.0 | 800 | 309 | 0 | 1.82 |
| | HDPE | | | | | | | | | | |
| H2 | Bimodal | CONTINUUM ™ | 1.5 | 0.955 | 28.3 | 9 | 22.1 | 690 | 364 | 0 | 2.94 |
| | HDPE | DMDC 1250 | | | | | | | | | |
| H3 | Unimodal | UNIVAL ™ DMDC | <1 | 0.952 | 23.4 | 10 | 37.9 | 900 | 176 | 0 | 2.64 |
| | HDPE | 6143 | | | | | | | | | |
| L1 | LDPE | DOW ™ LDPE 959S | 55 | 0.923 | 11.0 | 3 | 6.21 | 58 | <1 | 0.72 | 1.19 |

The HDPE and LDPE resins are blended in an extruder and pelletized in the proportions shown in Table 4, to make the HDPE compositions shown in Table 4. (Compositions IE1 to IE5 are examples of the invention. Compositions CE1 to CE6 are comparative examples.)

Appropriate amounts of HDPE (powder or pellet) are weighed, hand mixed and placed in a single auger screw K-tron T-20 polymer feeder. The feeder feeds the blend into a Coperion ZSK 25 mm twin-screw extruder (8 barrel, 44 L/D, electric heating and water cooling) with a gearbox ratio of 1:89 and a rotation speed up to 1200 RPM. Maximum torque for this line is 106 Nm. Barrel length is 1125 mm per with 11 barrels comprising the entire process section. Extruder barrel I.D. is 25 mm. Nitrogen padding (9.5 SCFH) is maintained at the feed throat during the compounding process. The screw design used for this project is the ZSK-25 mild screw. The residence time of material is controlled by the screw design, feed rate of 25 lbs/hr, screw RPM was 300. No oil is injected. No vacuum is used. A plug is added at the 8th barrel. No vent is used.

The compounded materials are extruded thru a 3 mm, 4 hole die into a 6 foot long chilled water bath. The strands are then passed thru a Huestis Air Block to remove excess water. Once the strands are cooled and dried, they are pelletized with the Conair strand pelletizer. The chopped pellets are dried overnight.

To evaluate the shrinkage anisotropy property, the molten resin is injection molded to form specimen plates following the ISO 294-4: 2018 standards using the conditions provided in Table 3. The injection molding machine is a Toyo SE110 injection molding machine.

TABLE 3
Processing conditions used in the injection molding machine

| | |
|---|---|
| Melt Temperature (° F.) | 428 |
| Injection velocity (cc/s) | 36 |
| Hold time (s) | 14 |
| Hold Pressure (psi | 7750 |
| Mold temperature (° F.) | 80 |
| Cooling time (s) | 10 |

The specimen plates are aged for 72 hours in a constant temperature and constant humidity atmosphere (73F and 50% relative humidity). Total shrinkage is measured in the directions parallel to the melt flow and normal to the melt flow direction. The plate dimensions are measured in each direction using optical method, measuring average length between the edges, leaving 3.175 mm at the corners. After obtaining the plate dimensions, total shrinkage in both directions is calculated using equations provided in ISO 294-4: 2018 standard. The shrinkage anisotropy is calculated as follows:

$$Shrinkage Anisotrophy = \frac{Total shrinkage in the parallel to the melt flow direction}{Total shrinkage in normal to the melt flow direction}$$

In addition, melt index and density of each HDPE composition is measured. Results are recorded in Table 4 and Table 5. As shown by the examples, the present invention reveals HDPE compositions having unexpectedly low shrinkage anisotropy. The HDPE compositions comprises an HDPE and LDPE component. The examples demonstrate that simply blending of a low shrinkage anisotropy HDPE with a high shrinkage anisotropy LDPE does not result in desirable shrinkage anisotropy. For example, blending of H3 and L1 at 99:1 (CE 5) and 90:10 (CE 6) weight ratio exhibit unexpectedly higher shrinkage anisotropy than either H3 (CE 6) or L1 (CE 7). By contrast, blending H1 and H2 with Li (e.g., IE 1, IE 2, and IE 3) results in HDPE compositions having desirable shrinkage anisotropy. Furthermore, the blending of H2 and L1 at 99:1 (IE 1) exhibits a lower shrinkage anisotropy than H2. But blending of H1 and L1 at the same ratio (CE 2) exhibits a higher shrinkage anisotropy than H1.

TABLE 4

| | | | | LDPE | | | | | | | | | | |
|---|---|---|---|---|---|---|---|---|---|---|---|---|---|---|
| | HDPE | | | | | Min | Composition Properties | | | | | | | |
| | | I_{2.16} | | | | LDPE | I_{2.16} | | | Yield | Yield | Break | Break | ESCR |
| | | (dg/ | | | | Conc | (dg/ | Density | Shrinkage | Stress | Strain | Stress | Elongation | (F50, |
| | HDPE | min) | % | LDPE | % | (%) | min) | (g/cm³) | Anisotropy | (MPa) | % | (MPa) | % | hr) |
| IE 1 | H2 | 1.5 | 99 | L1 | 1 | 0.75 | 1.47 | 0.954 | 2.76 | 27.6 | 8.7 | 22.6 | 790 | 378 |
| IE 2 | H2 | 1.5 | 90 | L1 | 10 | 0.75 | 1.81 | 0.953 | 2.41 | 25.4 | 9.7 | 22.1 | 850 | 162 |
| CE 1 | H2 | 1.5 | 100 | | 0 | 0.75 | 1.50 | 0.955 | 2.94 | 28.3 | 9.0 | 22.1 | 690 | 364 |
| IE 3 | H1 | 3.75 | 90 | L1 | 10 | 1.88 | 4.44 | 0.952 | 1.61 | 25.0 | 9.4 | 17.2 | 810 | 101 |
| CE 2 | H1 | 3.75 | 99 | L1 | 1 | 1.88 | 3.84 | 0.955 | 1.84 | 25.9 | 8.8 | 20.6 | 820 | 162 |
| CE 3 | H1 | 3.75 | 100 | — | 0 | 1.88 | 3.75 | 0.955 | 1.82 | 26.7 | 8.8 | 22.0 | 800 | 309 |
| CE 4 | H3 | 0.3 | 90 | L1 | 10 | <0.50 | <1 | 0.951 | 2.99 | 25.6 | 9.6 | 30.2 | 930 | 144 |
| CE 5 | H3 | 0.3 | 99 | L1 | 1 | <0.50 | <1 | 0.954 | 2.96 | 27.1 | 8.9 | 29.7 | 850 | 144 |
| CE 6 | H3 | 0.3 | 100 | — | 0 | <0.50 | 0.3 | 0.952 | 2.64 | 23.4 | 10 | 37.9 | 900 | 176 |
| CE 7 | | | | L1 | 100 | NA | 50.32 | 0.923 | 1.19 | 11.0 | 3 | 6.21 | 58 | <1 |

TABLE 5

| | | | | | | | Additional Composition Properties | | | | | | | | |
|---|---|---|---|---|---|---|---|---|---|---|---|---|---|---|---|
| | | | | | | | | | | Flexural | | | | | |
| | | | | | | | | | | Modulus | | | | | |
| | | | | LDPE | | | | | | (2% | | | | | |
| | HDPE | | | | | Min | | | | Secant. | | | | | |
| | | I_{2.16} | | | | LDPE | I_{2.16} | I₁₀ | I₂₁ | 0.05 | | | | | |
| | | (dg/ | | | | Conc. | (dg/ | (dg/ | (dg/ | in/min) | Mn | Mw | Mz | | |
| | HDPE | min) | Wt. % | LDPE | Wt. % | (wt %) | min) | min) | min) | (MPa) | (g/mol) | (g/mol) | (g/mol) | Mw/Mn | LCBf |
| IE 1 | H2 | 1.5 | 99 | L1 | 1 | 0.75 | 1.47 | 21.5 | 106 | 894 | 10,097 | 111,847 | 587,781 | 11.10 | 0.0001 |
| IE 2 | H2 | 1.5 | 90 | L1 | 10 | 0.75 | 1.81 | 25.7 | 123 | 793 | 10,144 | 109,915 | 594,875 | 10.84 | 0.009 |
| CE 1 | H2 | 1.5 | 100 | | 0 | 0.75 | 1.50 | | 100 | 982 | 9,766 | 122,102 | 683,970 | 12.50 | 0 |
| IE 3 | H1 | 3.75 | 90 | L1 | 10 | 1.88 | 4.44 | 62.9 | | 818 | 9,800 | 95,100 | 615,784 | 9.71 | 0.024 |
| CE 2 | H1 | 3.75 | 99 | L1 | 1 | 1.88 | 3.84 | 55.7 | | 850 | 9,760 | 96,700 | 617,676 | 9.91 | 0.013 |
| CE 3 | H1 | 3.75 | 100 | — | 0 | 1.88 | 3.75 | 53.5 | 278 | 880 | 9,620 | 101,000 | 716,202 | 10.40 | 0 |
| CE 4 | H3 | 0.3 | 90 | L1 | 10 | <0.50 | <1 | 3.06 | | 735 | 12,400 | 254,000 | 2,885,969 | 20.47 | 0 |
| CE 5 | H3 | 0.3 | 99 | L1 | 1 | <0.50 | <1 | 2.87 | | 799 | 12,700 | 269,000 | 2,900,566 | 21.20 | 0 |
| CE 6 | H3 | 0.3 | 100 | — | 0 | <0.50 | 0.3 | | 14 | 1,009 | 13,309 | 275,866 | 3,469,537 | 20.73 | 0 |
| CE 7 | | | | L1 | 100 | NA | 50.32 | | | NA | 9,225 | 67,563 | 314,520 | 7.32 | 0.72 |

1. A high density polyethylene composition comprising:
a) from 70.0 to 99.9 weight percent of high density polyethylene (HDPE) component having a density from 0.945 to 0.960 g/cm³ and a melt index (I_{2.16}, abbreviated MI_{H}) from 0.5 to 60 dg/min., and
b) a low density polyethylene (LDPE) component having a density from 0.900 to 0.930 g/cm³ and a melt index (I_{2.16}) from 5 to 100 dg/min., in a concentration of at most 30.0 weight percent and at least (a) 0.1 weight percent or (b) a weight percentage equal to 0.5×MI_{H}, whichever is greater,
wherein the high-density polyethylene composition has a density from 0.940 to 0.960 g/cm³ and a melt index (I_{2.16}) of no more than 70 dg/min and wherein weight percentages are based on the combined weight of the HDPE component and the LDPE component.

2. The high density polyethylene composition of claim 1, wherein the high-density polyethylene composition has a melt index (I_{2.16}) from 0.7 to 10 dg/min.

3. The high density polyethylene composition of claim 1, wherein the high-density polyethylene composition has a melt index (I_{2.16}) from 1 to 7 dg/min.

4. The high density polyethylene composition of claim 1, wherein the HDPE component has a melt index (I_{2.16}) no more than 12 dg/min.

5. The high density polyethylene composition of claim 1, wherein the HDPE component has a melt index (I_{2.16}) no more than 8 dg/min.

6. The high density polyethylene composition of claim 1, wherein the LDPE component has a density from 0.915 to 0.928 g/cm³.

7. The high density polyethylene composition of claim 1, wherein the LDPE component has a melt index (I_{2.16}) from 20 to 80 dg/min.

8. The high density polyethylene composition of claim 1, wherein the LDPE component has a long chain branching frequency is at least 0.30 per 1000 carbons.

9. The high density polyethylene composition of claim 1, wherein the weight percentage of the LDPE component in the high density polyethylene composition is at least 0.60×MI_{H}, based on the combined weight of the HDPE component and the LDPE component.

10. The high density polyethylene composition of claim 1, wherein the high density polyethylene composition comprises from 80 to 99 weight percent of the HDPE Component and from 2 to 20 weight percent of the LDPE component, based on the combined weight of the HDPE component and the LDPE component.

11. The high density polyethylene composition of claim 1, wherein the high density polyethylene composition has a density from 0.948 to 0.955 g/cm³.

12. The high density polyethylene composition of claim 1, wherein the high density polyethylene composition has a shrinkage anisotropy that is no more than 90 percent the shrinkage anisotropy of the HDPE component.

13. The high density polyethylene composition of claim 1, wherein the high-density polyethylene composition has a tensile yield stress of at least 24 MPa and an environmental stress crack resistance of at least 100 hours, when measured according to the Test Methods listed herein.

14. A process for making a molded article comprising the steps of: (1) injecting the high density polyethylene composition of claim 1 into a mold; (2) cooling the high density polyethylene composition in the mold until solidified; and (3) releasing the high density polyethylene composition from the mold.

15. A molded article comprising the high density polyethylene composition of claim 1.
